(19) United States
(12) Patent Application Publication
(10) Pub. No.: US 2013/0051529 A1
(43) Pub. Date: Feb. 28, 2013

(54) Method and System for Identification and Authentication of Objects

(71) Applicants: Arnab Basu, Belmont, Durham (GB); Ian Radley, Bishop Auckland Durham (GB); Max Robinson, Shincliffe Durham (GB)

(72) Inventors: Arnab Basu, Belmont, Durham (GB); Ian Radley, Bishop Auckland Durham (GB); Max Robinson, Shincliffe Durham (GB)

(73) Assignee: Kromek Limited

(21) Appl. No.: 13/580,441

(22) PCT Filed: Mar. 11, 2011
(86) PCT No.: PCT/GB2011/050484

§ 371 Date: Nov. 7, 2012

(30) Foreign Application Priority Data
Mar. 11, 2010 (GB) 1004024.4

(51) Int. Cl. G01N 23/20; B32B 3/00; G01T 1/24; B32B 1/02; G01T 1/36; G01N 23/083

(52) U.S. Cl. 378/64; 250/395; 250/393; 378/86; 250/370.12; 250/370.13; 428/98; 428/34.1

(57) ABSTRACT

A method and system for facilitating the identification and/or authentication of objects, and to a method and system for the marking of objects with an identity and/or as of authentic origin, and a set of objects marked to facilitate subsequent identification and/or authentication are described. The marking comprises incorporating into an object or part thereof or onto a tag mechanically engaged therewith a marker material exhibiting a characteristic radiation interaction response to incident high-energy ionizing radiation from a test source that is known to vary spectroscopically across the spectrum of the source. The presence or otherwise of the marker material may be determined by subsequent interrogation of an object with a suitable radiation source and detector to infer whether an object is of marked identity or origin.

This invention relates to a method and system for facilitating the identification and/or authentication of objects, to a method and system for the marking of objects with an identity and/or as of authentic origin, and to a set of objects marked to facilitate subsequent identification and/or authentication.

The invention particularly relates to a method and system for identification, verification and marking of products associated with specific authentication markings or the like attesting to genuine origin, quality, regulatory approval etc, such as security protected, limited edition, branded, protected origin, controlled standard or similar products and/or to a method and system for the identification and detection of counterfeit copies thereof. The invention particularly relates to a method and system making use of high energy radiation such as x-rays or gamma-rays to scan objects for identification and authentication purposes, and in particular to detect an authentication marker incorporated into or onto the object and/or its contents, for example for the authentication of a genuine product or the detection of a counterfeit product. The invention in particular relates to a method and system for identification, verification and marking of liquids, gels, pastes, powders and other like substantially homogenous materials within containers.

The invention may further relate to a method and system adapted to gather additional information about the internal contents and/or composition of the object. The invention may further relate to a method and apparatus that operates by or in conjunction with the generation of an image of the object. However it is not limited to such further information gathering or imaging.

It is known to be desirable to scan the contents of objects including, for example containers such as bottles, at security and customs checkpoints to gain information about content and to obtain an indication that the contents of the object do not constitute a threat to security or a breach of customs regulations. It is also known to be desirable to scan objects for other purposes such as quality control, content verification, degradation monitoring etc.

To ensure that an object or the contents thereof are what they are claimed to be, it may be useful to scan the object and contents so that a high energy ionising radiation beam traverses a cross section of the object. It can be possible to obtain an indication of the materials composition from a numerical analysis of the resultant transmitted radiation beam intensity data and to compare the results of that analysis with a reference data set relating to materials of known composition.

For example, WO2009/024818, WO2009/130492 and PCT/GB2010/050079 describe systems and methods which are intended to non-invasively identify target liquids held within sealed containers. The target liquids may be liquids which pose a security threat if carried on-board an aircraft, liquids containing dissolved narcotics, or liquids requiring quality control, for example. The systems and methods use an energy selective detector such as cadmium telluride to resolve the emergent, and for example transmitted radiation after interaction with the contained liquid spectroscopically. The spectroscopically resolved data may be analysed numerically to derive data representative of material transmission characteristics, for example by fitting to a known material property such as mass attenuation coefficient. Interrogating a database of target material transmission characteristics, and looking for matched transmission characteristics enables target materials to be identified.

Such a system might identify counterfeit objects which are qualitatively different from the genuine original, for example including contained liquids, gels, pastes, powders and other homogenous materials which are compositionally different. It might serve as a quality control to identify materially distinct copies. However if the counterfeit goods are a very close match to the real thing then the problem becomes more difficult. This situation can often arise since it is the brand status or the like that can be driving the cost of the product rather than the cost of manufacture. The value of the “original” over the “counterfeit” is more subjective and/or commercial in character. It lies in the brand identity, origin or like perceived subjective quality. The “original” good may otherwise be materially identical to the “counterfeit”. The added value is in the brand status or the like.

Branded and like goods may be provided with distinctive marking, packaging get up etc, but this may again be copied. Branded and like goods may be provided with authentication systems that include features that are harder to copy effectively. Recent developments in this regard have included incorporating physical security features that are hard to reproduce onto labels or packaging, such as holograms, watermarks, security printing and the like, and using identification code means such as bar codes, rfids and the like to provide identifiers for goods items in conjunction with reference databases. The provision of effective and secure means to authenticated branded and like goods which are hard to reproduce in counterfeit copies is a major concern for the producers and brand holders of high value branded products.

In accordance with the invention in a first most complete aspect a method for facilitating the identification and/or authentication of objects comprises: in a first marking phase:

incorporating into an object or part thereof or onto a tag mechanically engaged therewith a marker material exhibiting a characteristic radiation interaction response to incident radiation from a test ionizing radiation source that is known to vary spectroscopically across the spectrum of the source,
repeating the above steps for each of a plurality of objects to be marked with an identity and/or authentication marking,
recording the said characteristic response(s) across a plurality of and preferably at least three energy bands within the spectrum of the ionizing radiation source; and in a second, subsequent interrogation/authentication phase:
providing a radiation test source of ionizing radiation and a detector system therefor spaced therefrom, the detector system being capable of detecting and collecting spectroscopically resolvable information about radiation from the source incident thereon;
causing ionizing radiation from the ionizing radiation source to be incident upon the object, at least in the region of the marker material;
collecting intensity information about radiation received at the detector system after interaction with the object;
spectroscopically resolving the collected intensity information across a plurality of and preferably at least three energy bands within the spectrum of the source;
comparing the spectroscopically resolved intensity data with the recorded characteristic response of the expected marker material within predetermined tolerance limits to determine the presence of the expected marker material and thus gain an indication of identity and/or authenticity of the object.

In accordance with the invention, the radiation source is selected to be capable of producing a spectrum of emission over a range of energies within a desired operating bandwidth and the detector system is capable of resolving this spectroscopically across a plurality of and preferably at least three energy bands. It may be a single source or multiple sources. The radiation source comprises a source to deliver high-energy ionizing radiation, for example high energy electromagnetic radiation such as x-rays and/or gamma rays, or subatomic particle radiation, and the detection system is adapted correspondingly to detect radiation in this spectrum. The radiation source for example is a broadband source such as a broadband x-ray or gamma-ray source capable of producing broad spectrum emission over a wide range of energies. The detector system preferably exhibits a spectroscopically variable response across at least a part of the source spectrum allowing spectroscopic information to be retrieved and allowing intensity information to be detected at a plurality of differentiated energy bands across the spectrum of the source.

The general principles employed to exploit this spectroscopically resolved intensity data emergent from the object after radiation interaction with radiation from the source will be familiar.

An object under test is scanned by subjecting it to the source of incident radiation, for example by bringing it into a scanning zone defined between the source and the remotely spaced detector system, and by detecting at the detector system emergent radiation after interaction with the object. Suitably, a detector system is placed to detect emergent radiation from a radiation interaction that varies spectroscopically in a manner characteristic of material content.

Suitable emergent radiation includes transmitted and scattered, including coherent and incoherent scattering, and including forward and back scattering. Each is capable in principle of giving material-relevant information. The method is thus a method of collecting intensity data for emergent radiation from at least one such interaction mode.

For example, as will be familiar, the attenuation of radiation as it is transmitted through an object can give useful information both about the structure of the object and about its composition. The method thus may comprise collecting transmitted intensity data and determining the attenuation of incident radiation by an object in the scanning zone.

The invention is distinctly characterised in the way that this effect is exploited by addition of a specific marker material to a product, selected to give a detectable, and in particular spectroscopically variable, response to the incident radiation, which is not itself a part of the product but serves to mark the product, for example by way of a brand, guarantee of origin, guarantee of authenticity etc. The specific marker material is preferably selected to be functionless with respect to the normal function of the product (that is, to have no effect on qualitative function of the product, to be inert with respect to any composition etc) but to be readily detectable by the foregoing scanning procedure.

Thus, in accordance with the invention in the broadest aspect, during a marking phase such a selected marker material is incorporated into the object or into a selected part or region thereof, or is included into a tag mechanically engaged therewith. Either simultaneously or subsequently, but in any event before it becomes necessary to authenticate the object based on such a marking, data is stored in a data library which ties this marking to a characteristic radiation response to the radiation of the intended test source, for example by scanning with the test source at least so as to obtain emergent radiation data after interaction of incident radiation from the source with the part of the object carrying the marker. The resultant emergent radiation from this part of the object should have spectroscopically resolvable characteristics which are thus determined not only by compositional aspects of the underlying product but also by compositional aspects of the specifically added marker material.

During an interrogation/authentication phase, an object under test is scanned at least so as to obtain emergent radiation data after interaction of incident radiation from the source with the part of the object expected to carry the marker. The resultant emergent radiation from this part of the object should have the same spectroscopically resolvable characteristics which are thus determined not only by compositional aspects of the underlying product but also by compositional aspects of the specifically added marker material.

Thus, the emergent radiation produced after interaction with the marked object includes intensity data attributable both to the underlying product and to the additional marker material. A counterfeit copy which is merely an exact copy of the functional components of the object and/or of a functional product composition will not match the characteristic emergent radiation signal of the marked object. The marker provides an additional means for authentication of the object which should not be present in any alternative variant. The marker material may be selected to be a material which is relatively hard to introduce to the object, or may be introduced in a manner which is relatively hard to reproduce. The marker may then have significant effectiveness as an identifier for the object, an indicator of origin, an indicator of authenticity etc.

Suitably, the reference characteristic data and measured emergent radiation data are both resolved into at least three differentiated energy bands across the spectrum of the source. Suitably, the energy bands are the same for the marking and interrogation phase, but this is not necessary so long as a meaningful comparison can be made.

It will be understood that the overall methodology of the invention in the first complete aspect includes a marking phase and an interrogation/authentication phase which are likely to be carried out remotely from each other in space and time and independently.

Accordingly, the invention in a further aspect comprises a marking method to facilitate the subsequent identification and/or authentication of objects by irradiation from a test source. The method comprises:

incorporating into an object or part thereof or onto a tag mechanically engaged therewith a marker material exhibiting a characteristic radiation interaction response to incident radiation from a test ionizing radiation source that is known to vary spectroscopically across the spectrum of the source,
repeating the above steps for each of a plurality of objects to be marked with an identity and/or authentication marking,
recording the said characteristic response(s) across a plurality of and preferably at least three energy bands within the spectrum of the source.

The method produces objects suitably marked in accordance with the principles of the invention to be subject to the authentication phase of the first aspect of the invention as above described.

By analogy in a further aspect of the invention, a set of objects marked to facilitate subsequent identification and/or authentication is provided having been marked in accordance with the foregoing method.

That is to say, a set of objects marked to facilitate subsequent identification and/or authentication comprises a plurality of objects each of which incorporates within a body of the object or a part thereof or onto a tag mechanically engaged therewith a marker material exhibiting a characteristic radiation interaction response to incident high-energy ionizing radiation from a test source that is known to vary spectroscopically across the spectrum of the source.

For practical purposes, the set of objects is associated with a database comprising the said characteristic response(s) across a plurality of and preferably at least three energy bands within the spectrum of the intended test source.

By analogy in a yet further aspect, a system for facilitating the identification and/or authentication of objects comprises:

a set of marked objects as above described;
a database comprising the said characteristic response(s);
and an interrogation/authentication system comprising providing a radiation test source of ionizing radiation and a detector system therefor spaced therefrom, the detector system being capable of detecting and collecting spectroscopically resolvable information about radiation from the source incident thereon, a data processing apparatus for spectroscopically resolving the collected intensity information across a plurality of and preferably at least three energy bands within the spectrum of the source, a datalink in data communication with the said database of characteristic response(s), and a comparator to interrogate the database of characteristic response(s) and compare the spectroscopically resolved intensity data with the recorded characteristic response of the expected marker material within predetermined tolerance limits to determine the presence of the expected marker material and thus gain an indication of identity and/or authenticity of the object.

Where examples are used herein to illustrate aspects of the method and/or system it will be understood that these may be generally applied by analogy to all such aspects of the invention as applicable.

The detector system exploited by the principles of the invention is capable of detecting and collecting spectroscopically resolvable information about incident high-energy ionizing radiation in the sense that it is adapted to differentiate incident radiation simultaneously into plural separate energy bands across the spectrum of the source. For example, the detector system exhibits a spectroscopically variable response across at least a part of the source spectrum allowing such simultaneous differentiation of incident radiation into plural energy bands. The system and method are adapted to exploit this feature to resolve the resultant intensity dataset into plural energy bands and preferably at least three such energy bands across the spectrum of the source. The interrogation step comprises the collection and simultaneous resolution into plural separate energy bands across the spectrum of the source of radiation that has been incident upon the object to be authenticated.

The system and method thus produce a spectroscopically resolved emergent radiation dataset which is capable in principle of being analysed to extract information relevant to the composition of the object. Various theoretical relationships are known by which various radiation interaction modes can be fitted to material composition in accordance with various functional relationships. The invention is not limited to any particular relationship or to any particular radiation interaction theory or to any particular radiation interaction mode. It seeks to exploit in the generality of the principle that various such interactions exist.

Nor does the invention require particular numerical analysis to derive any materials property as such. It is sufficient that it inherently exploits a relationship whereby emergent radiation varies spectroscopically as a property of the material. It is capable of doing so merely by comparison. The system requires, at the first marking stage, the recording of a characteristic response for future reference at the interrogation/authentication stage. It is then necessary at the interrogation/authentication stage only to compare this recorded characteristic response with the actual response, within predetermined tolerance limits, to determine whether the response is that which would expected from an authentically marked object or not. It is not necessary to identify the marking material as such, to perform any compositional analysis of the object as such, or to derive any material properties as such. This enables the authentication step to be performed quickly, without full and detailed analysis, and thus it is made practical that an authentication step is performed simultaneously to, or at least closely and preferably immediately successively to, the interrogation step. Since the system exploited by the principles of the invention is capable of detecting and collecting incident radiation across plural separate energy bands and resolving the incident radiation simultaneously into those plural separate energy bands across the spectrum of the source, and since it is this resolution that is the basis for the authentication by comparison, authentication can be effected simultaneously to, or at least closely and preferably immediately successively to, the step of collection/resolution of the data. Discrete and temporally or spatially separate data collection and/or analysis and/or authentication phases are not required. Data may be processed and objects authenticated in real time in situ. The interrogation/authentication phase is thus performed for practical purposes as a single process in situ in real time.

The recorded characteristic response which is recorded at the marking stage therefore merely needs to be something with which a comparison can be made at the interrogation/authentication stage. Again, this may merely be an expected spectroscopically resolved intensity profile against which a comparison can be made. Optionally, the characteristic response data may be data which has been further analysed to derive particular information regarding material properties or particular compositional information, but this is not a necessary step.

The characteristic response data may be recorded in accordance with known theoretical principles based on the known behaviour of the marker material and/or via an initial recording step comprising scanning the object with a suitable radiation source and detector array, preferably comprising the scanning apparatus intended for use in the subsequent interrogation/authentication phase, at the time the object is marked or subsequently but before the interrogation/authentication phase.

In a typical application, objects will not be individually marked but will be batch marked. A single recordable characteristic data item or dataset may be recorded referenced to each object in such a batch, and for example in the case where an initial recording step is employed, a batch sampling process may be employed to obtain recordable characteristic data for an entire batch of similarly marked objects.

The invention in particular relates to the marking and authentication of objects comprising containers of contained materials. The invention in particular has effectiveness in relation to the marking and authentication of containers of contained materials expected to have relatively homogenous structure or contents. The invention in particular relates to objects comprising containers of contained materials which by their nature will be expected to have a single generally homogeneous composition, for example fluid compositions such as liquids, including mixtures, solutions, emulsions, suspensions etc, like flowable compositions such as gels, pastes, creams, fine powders, and the like, aerosols etc. Where reference is made herein by example to contained liquids in objects such as liquid containers it should be appreciated that the invention is equally applicable to all such liquid, partly-liquid and other flowable materials having this essential mixed and generally homogeneous character when contained.

In relation to this preferred case, where the invention is applied to containers comprising contained materials, and in particular contained materials having relatively homogenous composition, the marker material may be incorporated into the object comprising container and contents in one or more of the following three locations in particular:
a) incorporated into the material of the container, or a designated region of the container (for example a portion of the container wall) or a designated discrete part thereof (for example a top closure or the like) or onto a surface thereof;
b) incorporated in the composition of a tag attached thereto;
c) incorporated as an additional material added to and for example evenly distributed throughout the contents.

Preferably, wherever the target material is incorporated, it is incorporated in such manner as to make a generally uniform contribution to the characteristic radiation interaction of the object in that region. For example, the material is substantially evenly distributed in or on the object (or in or on the said region or part as the case may be) or tag.

For example, in the case of the three alternative arrangements given above the marker material may be:
a) applied evenly onto a surface of the container or distributed evenly within the material of the container (or in or on the said region or part as the case may be), for example by comprising an additional material incorporated into the composition thereof;
b) evenly dispersed in a structural carrier material of the tag;
c) incorporated into the contents, and in particular in the preferred case of a generally homogenous fluid or like content evenly distributed therein, and preferably comprising a material which is inert relative to the intended function of the said contents.

In a possible case the invention may at the authentication/interrogation stage exploit the collection and analysis of radiation after transmission through an object and contents under test. The invention in particular comprises a determination of the attenuation of that radiation relative to initial incident intensity. It is well known that the attenuation of transmitted radiation by a material is a specific material property which can be characteristically linked to and functionally related to certain physical parameters of the source radiation, such as incident intensity, incident energy etc. A suitable marker material may be selected comprising a material which gives a characteristic spectroscopically variable attenuation of radiation from the test source.

In the interrogation/authentication phase, the object being scanned can be held stationary in or positioned for movement through the scanning zone between the radiation source and the detector system as desired. the object being scanned can be positioned for movement in the vertical or horizontal plane depending on the application. For screening of fluids and the like in containers such as bottles and jars it is envisaged that the container will be mounted in a holder and moved through a generally vertical plane as mounting the container horizontally could result in spillage of contained materials. Mounting an object such as a bottle for vertical movement would require some sort of fastening to keep the object in place during the scanning movement so the object is preferably mounted at an angle of between 1° and 80° from vertical, preferably at an angle of between 5° and 45° and more preferably between 5° and 30°.

Many objects, such as containers, and for example bottles or cartons of liquids, have a regular shape defining a through thickness direction through which they might usually be scanned. For example such a thickness might be defined by the parallel sides of an object, or by diametrically opposite points on the surface of an object. The radiation beam can be arranged so that it is incident perpendicular to the surface of such an object. That is to say, it passes through an object normally to its surface and in such a through thickness direction. If the radiation beam is arranged to pass through the object at an angle other than perpendicular then the beam passes through an increased thickness of the object contents which can improve beam absorption and hence analysis of the object contents. For example, the radiation beam is preferably arranged to pass through an object at an angle of between 1° and 80° away from normal to the surface, preferably between 5° and 45° and more preferably between 5° and 30°, If the object is mounted at an angle of between 1° and 80°, preferably between 5° and 45° and more preferably between 5° and 30° such as is described above, then using a generally horizontal beam arrangement will give the desired increase in beam path length through the object contents. This will produce an enhanced interaction effect, in particular (though by no means only) when an attenuation interaction is being exploited.

For each “scanning event” (that is, for a given measurement of emergent intensity via a given radiation path incident upon and for example passing through an object in a given position) an “intensity dataset” is collected representing the collected intensity incident at the detector system across at least part of a source energy spectrum. Preferably, in accordance with the method of the invention, each such intensity dataset is resolved across at least two and more preferably at least three separate energy bands across the spectrum of the source. An intensity dataset thus constitutes a dataset of intensity information related to frequency/energy which is resolvable into such a plurality of bands to produce a corresponding plurality of emergent intensity data measurements relating to a given scanning event.

In cases where a marker is applied only to a part of an object, for example to a discrete region or discrete component thereof or to a tag attached thereto, separate scans may be performed with radiation incident upon the marked part and upon the unmarked. The additional data may for example be used for comparison and/or self-normalisation purposes to improve the accuracy of the process of the invention, or for analysis or imaging purposes other than those of the invention. Similarly, in the preferred case of contained homogenous fluids or the like, separate scans may be performed with radiation incident upon the marked part and upon the unmarked part of a container and/or with marked and unmarked contents and/or with filled and empty containers. Again, the additional data may for example be used for comparison and/or self-normalisation purposes to improve the accuracy of the process of the invention or otherwise.

In one possible embodiment, a single broad spectrum source may be used. In this embodiment the method of the invention may involve using a broad spectrum detector or detector array and/or a single narrow spectrum detector to detect incident radiation monochromatically. Alternatively incident radiation may be resolved spectroscopically with a single broad spectrum source incident upon a detector or detector array adapted to resolve information across the spectrum of source using the inherent properties of the detector and/or incident upon multiple detector arrays with narrow band responses.

Incident radiation is resolved spectroscopically across a plurality of energy bands and preferably at least three and more preferably at least five energy bands within the source spectrum. This can produce data susceptible of more powerful manipulation than monochromatic data. Thus, in this preferred case, the detector system is adapted to generate spectroscopic information about incident and especially transmitted radiation at least to the extent of resolving a plurality of energy bands and preferably at least three and more preferably at least five energy bands. Preferably, the detector exhibits a spectroscopically variable response across at least a substantial part of the spectrum of the radiation source allowing detailed spectroscopic information to be retrieved. However, the basis of the authentication process is a comparison step across the resolved signal in the plural energy bands rather than a full analysis, so a full spectrally resolved response is not required. A few energy bands are sufficient. Thus, incident radiation is resolved spectroscopically across a plurality of energy bands, preferably at least three and more preferably at least five energy bands within the source spectrum, but need not be resolved across a large plurality of energy bands, for example sixteen and for example eight may be a suitable maximum.

Similarly the source may be a single broad spectrum source across which a plurality of bandwidths or single energies may be identified. Alternatively or additionally sources may be provided having narrow bandwidths or generating incident radiation at one or more discrete energies to provide some of the energies for comparison in accordance with the method of the invention. In this case the radiation source is a plural source comprising a combination of sources at different energies to provide the necessary total spectrum spread to allow resolution by the detector across a plurality of energies/energy bands.

For example a plural source comprises an x-ray source having a relatively lower energy spectrum, for example operating below 60 keV and for example at 10 to 50 keV and one or more radioisotope sources generating radiation at higher energies, for example above 100 keV.

The source is preferably capable of generating a sufficiently broad spectrum of radiation to enable the spectral resolution necessary for the performance of the invention. Preferably the source generates radiation across at least one or more parts of the range of 20 keV to 1 MeV, and more preferably across at least a part, and for example a major part, of the range of 20 keV to 160 keV. For example the source generates radiation ranging across at least one bandwidth of at least 20 keV within the given range. For example the spectrum is such that at least three 10 keV bands can be resolved within that range.

It is preferable that the detector system is enabled to detect radiation in a manner which is spectroscopically resolvable by the data processing apparatus. Preferably, a detector system, or some or all discrete detector elements making up a multi-element system, may be adapted to produce spectroscopic resolution in that it exhibits a direct spectroscopic response. In particular a system or element is fabricated from a material selected to exhibit inherently as a direct material property a direct variable electrical and for example photoelectric response to different parts of the source spectrum. For example, the detector system or element comprises a semiconductor material or materials preferably formed as a bulk crystal, and for example as a bulk single crystal (where bulk crystal in this context indicates a thickness of at least 500 μm, and preferably of at least 1 mm). The materials making up the semiconductor are preferably selected from cadmium telluride, cadmium zinc telluride (CZT), cadmium manganese telluride (CMT), germanium, lanthanum bromide, thorium bromide. Group II-VI semiconductors, and especially those listed, are particularly preferred in this regard. The materials making up the semiconductor are preferably selected from cadmium telluride, cadmium zinc telluride (CZT), cadmium manganese telluride (CMT) and alloys thereof, and for example comprise crystalline Cd_{1-(a+b)}MnₐZn_{b}Te where a and/or b may be zero.

Combination of these and any other such materials may be considered which give spectroscopic detection rather than merely detecting amplitude of radiation after interaction with object and contents.

Preferably, a beam of a particular geometry, such as a pencil beam geometry or a fan or curtain beam, is used aligned perpendicular to direction of movement of the object.

In a preferred embodiment a simple pencil beam may be provided in conjunction with a simple single pixel detector or linear array detector. Alternatively, a beam may be collimated to have a spread in at least one dimension, for example in conjunction with one or more linear detectors. Only one pixel is needed for the detector if a pencil beam geometry is used. A linear array or area array used with a pencil beam can provide the capability to detect additional information such a scatter radiation. If a fan beam geometry is used a linear detector is preferred arranged perpendicular to the direction of movement of the object and within the area of the beam. Conveniently, a linear detector may comprise a linear array of a plurality of individual detector elements.

The radiation source is adapted to emit such a beam. A collimator is preferably provided between the source and the object under test, for example in the vicinity of the source, to produce an emitted beam of suitable geometry from the source. In particular, the source beam is collimated to produce a pencil beam.

Additionally or alternatively, the beam may be collimated after interaction with object and contents under test, for example in the vicinity of the detector, to allow transmitted radiation to pass to the detector but for example to restrict any scatter radiation from reaching the detector.

At its simplest, the invention relies upon the extracting from emergent intensity data at multiple spectral bands of a dataset characteristic of material composition in the incident radiation path and the making a suitable library comparison to detect the presence of an expected marker material. It need not generate compositional data per se or an image of the object. However, it is not excluded that the invention may form part of a scanning system to generate such compositional data per se and/or such an image of the object.

In accordance with this possible embodiment, the dataset of information about radiation incident at the detector, or at a further detector, is numerically analysed to generate information regarding the composition of an object in the scanning zone and/or used to generate an image of an object in the scanning zone.

Preferably the method comprises collecting data regarding the intensity of transmitted radiation after interaction with an object in the scanning zone and the data regarding the intensity of transmitted radiation is processed at the detector, or at a further detector, numerically to generate information regarding the composition of the object in the scanning zone and/or used to produce one or more images and for example a succession of images as an object moves through the scanning zone.

For clarification it should be understood that where used herein a reference to the generation of image is a reference to the creation of an information dataset, for example in the form of a suitable stored and manipulatable data file, from which a visual representation of the underlying structure of the object under investigation could be produced, and references to displaying this image are references to presenting an image generated from such a dataset in a visually accessible form, for example on a suitable display means.

The method of the invention conveniently further provides the additional step of displaying such generated image or images, and in the case of multiple images might involve displaying such images simultaneously or sequentially.

Each collected image may be resolved spectroscopically across a plurality of bands each intended to generate an image across a part of the overall spectrum, so that the bands together allow the generation of an energy-differentiated composite image or succession of images.

The invention will now be described by way of example only with reference to the accompanying drawings in which:

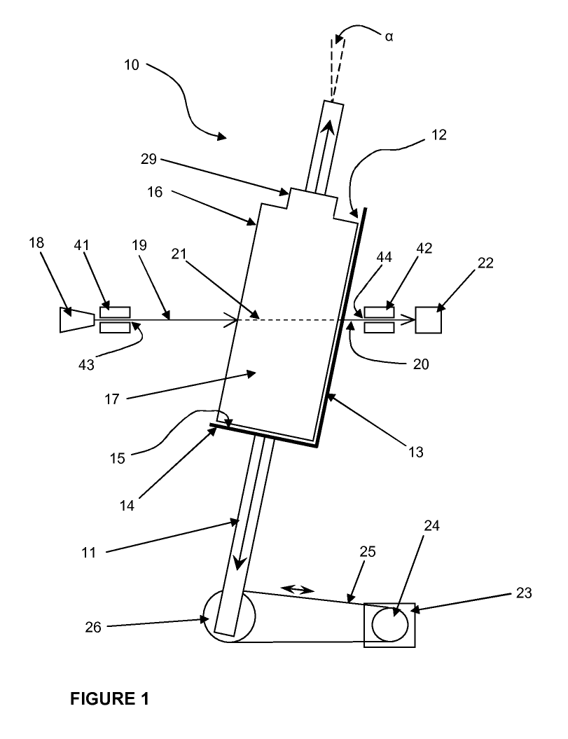

FIG. 1 is a schematic representation of an apparatus of the invention for in an example embodiment with a bottle carrying a marked liquid;

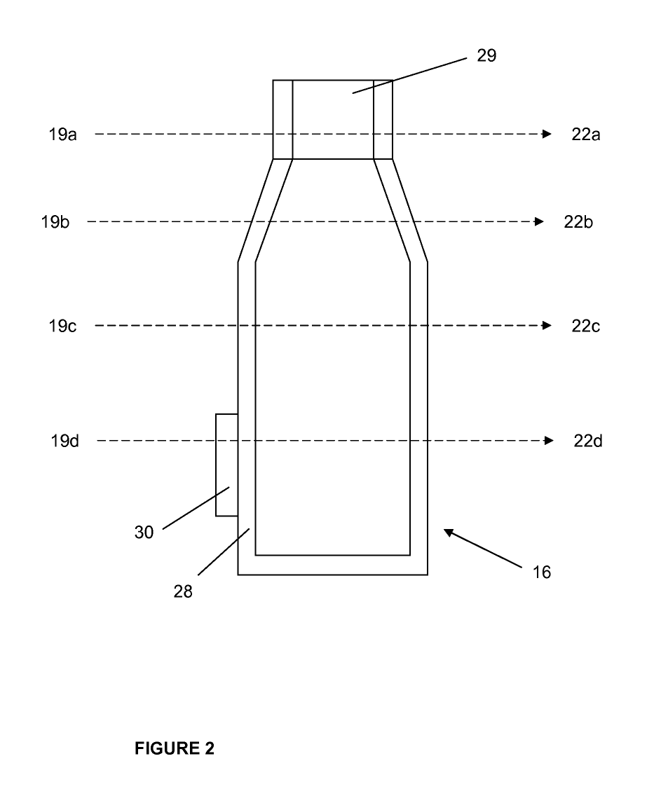

FIG. 2 is a representation of alternative marker structures and ray paths for such alternative structures;

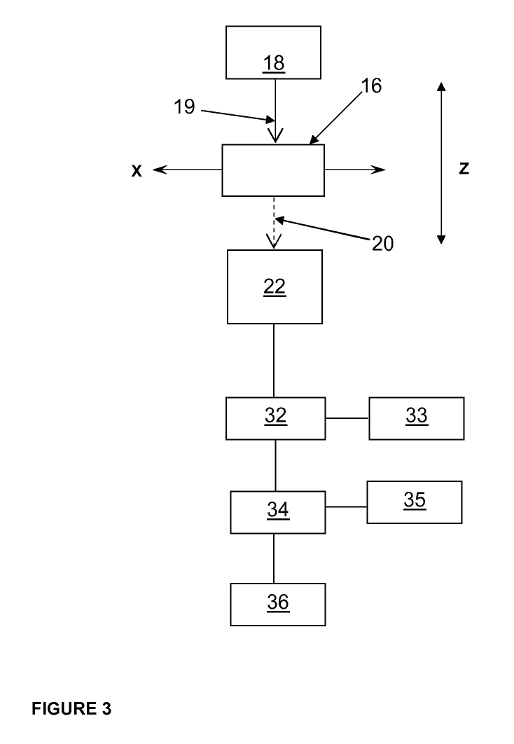

FIG. 3 is general schematic of a possible apparatus to implement the invention via an apparatus such as that of FIG. 1;

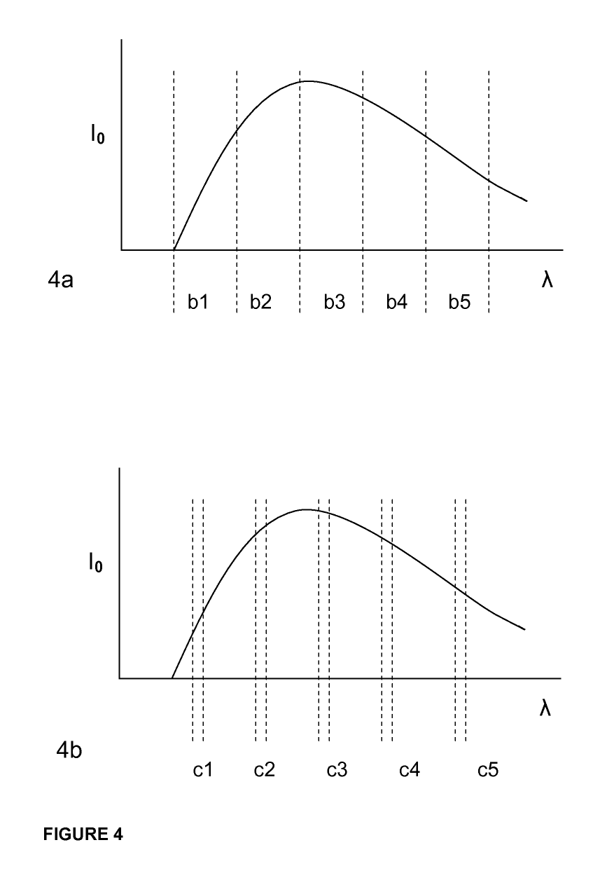

FIG. 4 illustrates a typical radiation source spectrum, and illustrates how it is partitioned to implement the invention in conjunction with an imaging operation.

An example is given hereinbelow in which a radiation scanner is used in an interrogation/authentication phase to detect attenuation of transmitted radiation. However, it should be understood that this merely illustrates the principles of the invention. Any radiation interaction mode that produces emergent radiation, at least from the target material, that gives a characteristic spectroscopic response, can be exploited. In other cases for instance a marker material producing a distinctive back-scattered response might be particularly effective. Moreover, the invention may exploit the same or different modes of interaction for detection of marker material according the principles of the invention and for additional compositional analysis or imaging according to conventional principles. The skilled person will readily appreciate those aspects of the example hereinbelow which could be applied by analogy to such other cases.

In the apparatus of the invention illustrated in FIG. 1 an embodiment of a possible apparatus to implement the invention is shown comprising a bottle scanner for scanning liquids in bottles and like objects using an x-ray source as a source of high-energy ionizing radiation.

The bottle scanner 10 is provided with a linear slider shaft 11 to move a bottle holder 12 that is fixedly connected to the linear slider shaft 11 for movement therewith. The linear slider shaft 11 is capable of moving the bottle holder 12 in two directions.

The bottle holder 12 comprises a back member 13 against which the bottle 16 rests and a base member 14 with a top surface 15 onto which the bottle 16 sits. The bottle 16 is nested against and into the bottle holder 12 by virtue of the holder and linear slider shaft being inclined at an angle α. In the example this might be an angle of 15° from vertical. For a bottle, an angle of between 5° and 30° might be convenient. Other shapes of objects or containers might be held at different optimum angles.

The bottle holder back member 13 is preferably provided with an opening (not shown) to allow a clear path for the x-ray beam to pass from the bottle to the detector. The opening in the back member 13 could be a slot shaped aperture running from the top to the bottom of the back member. The slot aperture could be a narrow slot that provides some beam collimation with a width sufficient to allow the beam to pass through unimpeded but narrow enough to restrict any scatter radiation from reaching the detector 22. Additional or other alternative collimation of the beam on the transmission side could be provided.

The movement of the bottle holder 12 and bottle 16 along the linear slider shaft 11 is caused by the rotation of the electrically powered stepper motor 23. The motor causes the pulley 24 to rotate, which drives belt 25 which, in turn, drives the rotation of pulley 26. The rotational motion of pulley 26 is converted into a rotation of a suitable drive such as a screw drive (not shown) in the linear slider shaft 11 which creates the linear motion of the bottle holder 12.

The motor is capable of rotation in either direction and by controlling the direction of rotation of the motor the direction of movement of the bottle holder 12 and bottle 16 can be determined.

As the bottle is moved along the direction of the linear slider shaft it is caused to pass through an x-ray beam 19. The incident beam 19 is generated by a source 18, preferably a tungsten source so that it has a broad spectrum of energies present in the beam.

The x-ray beam 19 is aligned horizontally. As the bottle is inclined at an angle α from the vertical the beam does not strike the bottle perpendicular to the bottle's surface. This preferred arrangement gives an increased absorption path for the beam as it passes through the bottle and its contents.

The incident beam 19 passes through the bottle 16 and bottle contents 17 where absorption and scatter will take place along beam path 21 before the transmission beam 22 emerges from the bottle and is detected by detector 20.

The x-ray beam in the embodiment is collimated by primary collimator 41 provided with aperture 43 and positioned close to the source 18 and is preferably a pencil beam with one dimensional geometry.

The transmission x-ray beam 20 in the embodiment is collimated through an appropriate aperture 44 in secondary collimator 42 before it arrives at detector 22.

The detector 22 in the embodiment is a single pixel aligned with the collimated x-ray beam. The detector generates a signal representative of the intensity and energy of interactions with photons from the transmission x-ray beam 20. These signals are then processed as detailed in FIG. 2 below. In the embodiment the detector comprises material capable of spectroscopic resolution of incident x-rays, and in the specific example comprises cadmium telluride (CdTe) although it will be appreciated that alternative materials could be used.

Additional analysis capability could be provided by the use of additional detectors to detect those parts of the x-ray beam that have been scattered in the forward and/or backwards directions. The transmission beam 20 and forward scattered x-ray beams could be detected by the use of linear or area arrays.

In the embodiment illustrated in FIG. 1 it is envisaged that the liquid contents 17 of the container have an added marker material dispersed within. This marker material is intended to be inert as far as the normal function of the liquid contents is concerned, but to exhibit a distinct and characteristic x-ray response, and in particular one that varies characteristically with energy across the spectrum. This characteristic response is recorded at an initial marking stage, for example by operating the apparatus on the contained liquid (or on a sample of batch of such containers).

The embodiment works on the principle that the contents 17 of the container are liquid and hence essentially homogenous, and that the marker material may be essentially homogenously distributed therein. Of course, the same principles could be applied to any contained materials which by their nature will be expected to have a single generally homogeneous composition, for example fluid compositions such as liquids, including mixtures, solutions, emulsions, suspensions etc, like flowable compositions such as gels, pastes, creams, fine powders, and the like, aerosols etc. The marker material is evenly distributed therein, for example in solution, suspension, emulsion etc or otherwise as a component of the compositional mixture.

Additionally or alternatively, a marker material may be incorporated into the container 16 and/or a marker tag may be affixed to the container. Possible structures and ray paths for such alternatives are shown in FIG. 2.

For example a marker material may be included in the material of the bottle wall 28, in the bottle top 29 etc, or into a marker tag 30 affixed to the container.

Example incident ray paths 19a to 19d are shown. Ray path 19a is incident upon the bottle top 29 and will produce a transmitted ray 22a from which could be derived details of the composition of the top, which may carry a marker material in accordance with the principles of the invention. Ray paths 19b and 19c are incident upon the bottle wall 28 and will produce a transmitted ray 22b, 22c from which could be derived details of the composition of the wall and (depending upon fill level) contents, either or both of which may carry a marker material in accordance with the principles of the invention. Ray path 19d is incident upon a marker tag 30 and will produce a transmitted ray 22d from which could be derived details of the composition of the tag, wall and contents. The tag may carry a marker material in accordance with the principles of the invention additionally to or as an alternative to the wall and/or contents.

Additional data may be collected which is not influenced by a marker material. For example where the contents are marked data may be collected by scanning an empty container and or by scanning through an incident path that passes only through container wall and not contents. In alternative cases where marker material is carried by a designated region of the container, for example a portion of the container wall 28 or a designated discrete part thereof such as the top closure 29 or a bespoke tag 30, data may be collected with incident radiation that impinges upon the designated region and with incident radiation that impinges elsewhere.

Thus, radiation interaction data is collected at least from a region where the interaction is characteristically influenced by the marker material, and optionally also from elsewhere. This can be stored in a data library for subsequent reference in the interrogation phase to determine whether the marker material is present in an object under test and thus to identify or authenticate the object.

A possible process chart for the interrogation phase is reference in FIG. 3. In the general schematic representation of FIG. 3, a single ray path only is shown for simplicity. An x-ray source 18 and laterally spaced detector apparatus assembly 22 together define a scanning zone Z between them. In use, a bottle to be scanned is brought into an x-ray beam path by being placed in a bottle holder such as that shown in FIG. 1 and being moved in direction X through the scanning zone by a mechanism such as that described in FIG. 1 such that the x-ray beam passes through the bottle along its axis.

In the illustrated example, a bottle sits in the scanning zone Z. An incident beam 19 from the x-ray source is illustrated. In this simple schematic, the incident beam is represented by the line 19. The transmitted beam 20 is incident upon a single detector 22.

The detector 22 is in data communication with a processor 32. The inherent spectral resolution of the material in the detector allows the processor 32 to resolve this image differentially across a plurality of pre-set frequency/energy bands in accordance with the principles of the invention by reference to energy band boundaries stored in the data register 33.

In the example embodiment a tungsten x-ray source, is used. A typical spectrum such as might be generated by tungsten of initial intensity against wavelength is illustrated in FIG. 4.

The main purpose of FIG. 4 is to illustrate two possible ways in which the spectrum may be resolved in accordance with a possible embodiment. In each case, the spectrum is shown resolved across five frequency bands.

The schematic illustrates two ways in which the spectrum may be resolved. In FIG. 4a, the bulk of the generated spectrum is divided between five relatively broad energy bands b1 to b5. In FIG. 4b, five relatively narrow bands, which may approximate even to individual energies, are defined c1 to c5. Neither alternative is in contradiction with the principles of the invention, and any combination may be used to generate useful results.

In the example embodiment, the data is used to characterise the material contents of the bottle 16 under investigation so as to determine the presence of the marker material distributed within the contents. The same principles would apply generally where the marker material was incorporated into the container or on tag thereon. In the example embodiment, the data is analysed numerically.

Resolved data from the processor 32 is passed to a comparator 34 which is able to interrogate a data library 35 in which is stored the reference data generated at the marking stage. This may be a manually or automatically addressed library, but in the embodiment is addressed automatically via a datalink. The comparator compares the results generated by the processor 32 with expected data stored in or derivable from the reference data in the library 35, within suitable tolerance limits, to derive an indication of the presence of the expected marker.

Supplementary additional analysis and/or comparisons may be made based on the spectroscopically resolved data to improve the accuracy of the result (for example the composition of the bottle and/or contents may also be analysed and compared with expected compositional data) but this is not necessary to the invention.

A result is output by the result module 36, based at least on the determination of the absence or presence of the expected marker, and optionally on other analysis. The absence of the expected marker will typically be presented as a failure of authentication. The presence of the expected marker may be presented as a pass (subject to any supplementary analysis and/or comparisons).

This may be a manually or automatically addressed library. Data may be preloaded or referenced, or may be generated or added to over time by operation of the apparatus with known materials.

1. A marking method to facilitate the subsequent identification and/or authentication of objects by irradiation from a test ionizing radiation source comprises the steps of:
incorporating into an object or part thereof or onto a tag mechanically engaged therewith a marker material exhibiting a characteristic radiation interaction response to incident radiation from a test ionizing radiation source that is known to produce emergent radiation that varies spectroscopically across the spectrum of the source in a manner characteristic of material content, wherein the radiation interaction comprises one or more of: photoelectric absorption, incoherent and coherent scattering,
repeating the above steps for each of a plurality of objects to be marked with an identity and/or authentication marking,
recording data relating to the said characteristic response(s) resolved across a plurality of energy bands within the spectrum of the source.

2. A method in accordance with claim 1 wherein the data relating to the said characteristic response(s) are resolved across at least three energy bands within the spectrum of the source.

3. A method in accordance with claim 1 wherein the characteristic response data are calculated and recorded in accordance with known theoretical principles based on the known behaviour of the marker material.

4. A method in accordance with claim 1 wherein the characteristic response date are generated via an initial recording step comprising scanning the object with a suitable ionizing radiation source and detector array.

5. A method in accordance with claim 1 wherein objects are batch marked and a single recordable characteristic data item or dataset is recorded to be referenced to each object in such a batch.

6. A method in accordance with claim 1 wherein the target material is incorporated in such manner as to make a generally uniform contribution to the characteristic radiation interaction of the object or region thereof or tag where so incorporated in that it is substantially evenly distributed in or on the object or region or tag.

7. A method in accordance with claim 1 wherein the objects comprise containers of contained materials which by their nature will be expected to have a single generally homogeneous composition.

8. A method in accordance with 7 wherein the marker material is incorporated in one or more of the following three locations:
a. into the material of the container, or a designated region of the container or a designated discrete part thereof or onto a surface thereof;
b. in the composition of a tag attached thereto; or
c. as an additional material added to and evenly distributed through the contents.

9. A method in accordance with claim 8 wherein the marker material is incorporated into the object in one or more of the following ways:
a. applied evenly onto a surface of the container or distributed evenly within the material of the container, (or in or on the said region or part by comprising an additional material incorporated on or into the composition thereof;
b. evenly dispersed in a structural carrier material of the tag; or
c. incorporated into the contents and evenly distributed therein.

10. A method for facilitating the identification and/or authentication of objects comprising:
in a first marking phase:
applying the marking method of claim 1 to a plurality of objects to be marked;
and in a second interrogation/authentication phase:
providing a test source of ionizing radiation and a detector system therefor spaced therefrom, the detector system being capable of detecting and collecting spectroscopically resolvable information about radiation from the source incident thereon;
causing ionizing radiation from the ionizing radiation source to be incident upon the object, at least in the region of the marker material;
collecting intensity information about radiation received at the detector system after interaction with the object;
spectroscopically resolving the collected intensity information across a plurality of energy bands within the spectrum of the source; and
comparing the spectroscopically resolved intensity data with the recorded characteristic response of the expected marker material within predetermined tolerance limits to determine the presence of the expected marker material and thus gain an indication of identity and/or authenticity of the object;
wherein the detector system is placed to detect emergent radiation from a radiation interaction that varies spectroscopically in a manner characteristic of material content, and
wherein the radiation interaction comprises one or more of: photoelectric absorption, incoherent and coherent scattering.

11. A method in accordance with claim 10 comprising the step of spectroscopically resolving the collected intensity information across at least three energy bands within the spectrum of the source.

12. A method in accordance with claim 10 comprising use of a detector inherently capable of resolving incident radiation simultaneously across a plurality of energy bands within the spectrum of the source

13. (canceled)

14. (canceled)

15. A method in accordance with claim 10 wherein the radiation source comprises a source to deliver high energy electromagnetic radiation selected from x-rays and/or gamma rays, or subatomic particle radiation.

16. A method in accordance with claim 15 wherein the source is an x-ray source.

17. A set of objects marked to facilitate subsequent identification and/or authentication comprising a plurality of objects each of which incorporates within a body of the object or a part thereof or onto a tag mechanically engaged therewith a marker material exhibiting a characteristic radiation interaction response to incident radiation from a test source that is known to vary spectroscopically across the spectrum of the source.

18. A set of objects in accordance with claim 17 associated with a database comprising the said characteristic response(s) across a plurality of energy bands within the spectrum of the intended test source.

19. A set of objects in accordance with claim 17 wherein the target material is incorporated in such manner as to make a generally uniform contribution to the characteristic radiation interaction of the object or region thereof or tag where so incorporated in that it is substantially evenly distributed in or on the object or region or tag.

20. A set of objects in accordance with claim 17 wherein the objects comprise containers of contained materials which by their nature will be expected to have a single generally homogeneous composition.

21. A set of objects in accordance with claim 17 wherein the marker material is incorporated in one or more of the following locations:
a. into the material of the container, or a designated region of the container or a designated discrete part thereof or onto a surface thereof;
b. in the composition of a tag attached thereto; or
c. as an additional material added to and evenly distributed through the contents.

22. A set of objects in accordance with claim 21 wherein the marker material is incorporated into an object in one or more of the following locations:
a. applied evenly onto a surface of the container or distributed evenly within the material of the container, or in or on the said region or part by comprising an additional material incorporated on or into the composition thereof;
b. evenly dispersed in a structural carrier material of the tag; or
c. incorporated into the contents and evenly distributed therein.

23. A system for facilitating the identification and/or authentication of objects comprising:
a set of marked objects in accordance with claim 17;
a database comprising the said characteristic response(s); and
an interrogation/authentication system comprising providing a radiation test source of ionizing radiation and a detector system therefor spaced therefrom, the detector system being capable of detecting and collecting spectroscopically resolvable information about radiation from the source incident thereon, a data processing apparatus for spectroscopically resolving the collected intensity information across a plurality of energy bands within the spectrum of the source, a datalink in data communication with the said database of characteristic response(s), and a comparator to interrogate the database of characteristic response(s) and compare the spectroscopically resolved intensity data with the recorded characteristic response of the expected marker material within predetermined tolerance limits to determine the presence of the expected marker material and thus gain an indication of identity and/or authenticity of the object.

24. A system in accordance with claim 23 wherein the detector system is adapted to differentiate incident radiation simultaneously into plural separate energy bands across the spectrum of the source.

25. A system in accordance with claim 24 wherein a detector is adapted to produce spectroscopic resolution in that it is fabricated from a material selected to exhibit inherently as a direct material property a direct variable electrical response to different parts of the source spectrum.

26. A system in accordance with claim 25 wherein the semiconductor material is selected from cadmium telluride, cadmium zinc telluride (CZT), cadmium manganese telluride (CMT), germanium, lanthanum bromide, thorium bromide.

27. A system in accordance with claim 26 wherein the semiconductor material comprises crystalline Cd_{1-(a+b)}MnₐZn_{b}Te, where a+b<1 and a and/or b may be zero.

28. A system in accordance with one of claims 23 to 27 wherein the radiation source comprises a source to deliver high energy electromagnetic radiation selected from x-rays and/or gamma rays, or subatomic particle radiation.

29. A system in accordance with claim 28 wherein the source is an x-ray source.
